(19) United States
(12) Patent Application Publication
(10) Pub. No.: US 2011/0212536 A1
(43) Pub. Date: Sep. 1, 2011

(54) METHOD AND APPARATUS FOR THE ISOTOPE-RATIO ANALYSIS

(76) Inventors: Michael Krummen, Oldenburg (DE); Johannes Schwieters, Ganderkesee (DE)

(21) Appl. No.: 12/742,364

(22) PCT Filed: Oct. 28, 2008
(86) PCT No.: PCT/EP2008/009078

§ 371 Date: Jul. 9, 2010

(30) Foreign Application Priority Data
Nov. 13, 2007 (DE) 10 2007 054 419.9

(51) Int. Cl. G01N 30/02; B01D 59/44; G01N 21/59

(52) U.S. Cl. 436/161; 422/70; 73/61.52; 250/282; 356/437

(57) ABSTRACT

A process and to an apparatus for isotope ratio analysis having the steps of: performing an LC process and thus providing a first eluate which comprises at least one first liquid carrier fluid and one or more analytes, collecting a portion of interest from the eluate, processing the eluate portion of interest by combining with a second liquid carrier fluid and removing the first carrier fluid to form a processed eluate portion, processing the processed eluate portion to form one or more gaseous conversion products of the analytes, and supplying the gaseous conversion products with gaseous carrier fluid to an isotope analyzer and determining the isotope ratios.

### BACKGROUND OF THE INVENTION

1. Technical Field.

The invention relates to a process and to an apparatus for isotope ratio analysis.

2. Prior Art.

To perform isotope ratio analysis, high-precision isotope analyzers are used, for example specific mass spectrometers (IRMS), laser absorption measurement devices or other suitable analyzers. Generally gaseous substances have to be supplied to the analyzers. Special features therefore have to be taken into account in the analysis of liquids or solids. The latter can be provided, for example, as a mixture via a liquid chromatograph (LC or HPLC). In the liquid chromatograph, the substances dissolved in the liquid are separated in terms of time. Liquid chromatography is applied, inter alia, to substances which contain carbon, nitrogen, oxygen, hydrogen and/or sulfur. To determine the isotope ratio of the elements mentioned, a conversion of the substances (analytes) to gaseous conversion products is required. Suitable gases are typically at least H₂, CO, CO₂, N₂ and SO₂.

The coupling of a liquid chromatograph to an IRMS is, for example, known from DE 102 16 975. According to the process described there, gas is obtained from the eluate of a liquid chromatograph in the presence of the eluate. The analysis substances dissolved in the eluate are converted to the gas. Subsequently, the gas is separated from the eluate and supplied to the IRMS.

A special feature is also isotope ratio analysis on the basis of liquid organic samples, for example to determine the carbon isotopes 13C and 12C. Suitable processes for taking account of the carbon present in an analysis substance from soluble compounds or only from organic compounds are disclosed in DE 10 2004 010 969.

DE 10 2005 049 152 discloses subjecting the eluate of a liquid chromatograph to an electrolysis to form and provide a gaseous substance or a precursor for a substance which can be analyzed by an IRMS.

Finally, it is known that liquid or solid samples can be converted by pyrolysis or oxidation in what is known as an element analyzer, thus providing constituents of interest in gaseous form for an isotope analysis. Such an element analyzer is, for example, the Finnigan TC/EA from Thermo Electron Corporation.

A common feature of the known processes is that the provision of the gaseous substance for the isotope analysis cannot be performed in any desired manner. At least for reasons of cost and measurement technology, the gaseous substances can be formed only from particular eluates. Such ideal eluates are frequently not available. This is especially true in the determination of isotope ratios in pharmaceuticals, pesticides, food additives and other substances which contain relatively large molecules.

From the point of view of the user, there often exists a wide range of analysis devices for qualitative determination of substances. These also include high-performance liquid chromatographs (HPLC), which can additionally be tuned to specific substances. Such a specific HPLC system is known from Analytical Chemistry, 1998, vol. 70, 409-414, Gillian P. McMahon and Mary T. Kelly “Determination of Aspirin and Salicylic Acid in Human Plasma by Column-Switching Liquid Chromatography Using On-Line Solid-Phase Extraction”. What is disclosed is an HPLC in which an injected sample is first entrained by a solvent and conducted through a first column. Subsequently, a portion of the sample is discharged from the first column by a mobile phase and conducted through a second column. The eluate of the second column is passed through a UV detector and analyzed there. Owing to the solvent present, the eluate is unsuitable for immediate conversion to a gas suitable for isotope analysis. In this case, the user will have to adjust the HPLC process for analysis of aspirin and salicylic acid to the particular features of the isotope analysis. The present invention starts from this point in particular.

### BRIEF SUMMARY OF THE INVENTION

The aim of the present invention is the provision of a process and of an apparatus, such that the user can retain the established LC process (especially HPLC process), and an isotope ratio analysis is possible at the same time. For this purpose, the process according to the invention has the following steps:

a) performing an LC process and thus providing a first eluate which comprises at least one first liquid carrier fluid and one or more analytes,
b) collecting a portion of interest from the eluate,
c) processing the eluate portion of interest by combining with a second carrier fluid and removing the first carrier fluid to form a processed eluate portion,
d) processing the processed eluate portion to form one or more gaseous conversion products of the analytes,
e) supplying the gaseous conversion products with gaseous carrier fluid to an isotope analyzer and determining the isotope ratios.

With the process according to the invention, it is now possible for the first time to subject virtually all substances suitable for LC to isotope ratio analysis. At the same time, the user can retain the tried and tested LC or HPLC processes. Between the user's LC process and the supply of the gas to the isotope analyzer are inserted additional process steps which enable connection of the known processes to one another. An important step is the “cutting out” of the components of interest from the eluate of the LC process. The “cutting out” can be effected, for example, by especially program-controlled switching between different lines at the outlet of the LC device. The component of interest “cut out” in such a way is then optionally stored intermediately or processed immediately and hence provided in another carrier fluid. This second carrier fluid is individually selected and matched to the eluate of the LC process on the one hand, and to compatibility with process steps still to follow, more particularly the possibility of formation of a gaseous conversion product of the analytes.

According to a further concept of the invention, the portion of interest from the eluate can be collected, stored intermediately and then processed. One means of intermediate storage is the collection of the portion of interest from the eluate on a separating column or in a line section. It is also possible for the first time for the eluate portions of interest to be collected and stored several times in succession. This allows greater amounts to be processed.

In a further development of the invention, it is envisaged that the portion of interest from the eluate, upstream of the separating column, is collected, stored intermediately and conducted together with the second liquid carrier fluid through the separating column.

According to a further concept of the invention, it is envisaged that the eluate portion is first combined with the second carrier fluid and then the first carrier fluid is removed. However, a reverse procedure is also possible, i.e. the removal of the first carrier fluid, for instance by evaporation (also by means of laser), and the subsequent combination of the eluate portion with the second carrier fluid.

According to a further concept of the invention, it is envisaged that the second carrier fluid with the eluate portion or the second carrier fluid and the eluate portion which has been freed of the first carrier fluid are conducted through a separating column, and that a portion of interest from the second eluate obtained is removed and provided for the processing of the eluate portion of interest by combining with the second liquid carrier fluid and removing the first carrier fluid to form a processed eluate portion. In this case, the portion of interest from the second eluate corresponds to the processed eluate portion.

Advantageously, the portion of interest from the second eluate is stored intermediately on the separating column. Thence, the second eluate portion can be provided in a simple manner for the further steps.

According to a further concept of the invention, it is envisaged that the processed eluate portion (second eluate) is treated physically, chemically and/or electrochemically to form the desired gaseous conversion products. Advantageously, a gas which comprises the desired analytes or conversion products thereof is obtained from the eluate portion, said gas being separated from the liquid at least at a membrane. The gas can be obtained beforehand, for example, by heating (also by means of laser), by adding acid or electrolytically. Further means of obtaining gas are possible.

The processed eluate portion can also be heated to form the desired gaseous analytes or conversion products thereof, the boiling temperature of the liquid carrier fluid in the eluate portion being lower than the boiling temperature of the analytes. As a result, the analytes are converted later to the gaseous form and can then be combusted.

To form the desired gaseous conversion products of the analytes, the processed eluate portion can also be thermally decomposed in a reactor or be obtained by electrolytic reaction of the eluate. It is also possible that only precursors of the conversion products are obtained in this way. The precursors are then subjected to further process steps. The volumes of the reactor are adjusted to the expected amounts of analyte.

Advantageously, the isotope analyzers provided are an isotope mass spectrometer (IRMS) or a laser absorption measurement device.

According to a further concept of the invention, it is envisaged that the collected portion of interest from the eluate is heated until the liquid carrier fluid evaporates, and that an unevaporated portion comprises the analytes and is combined with the second liquid carrier fluid and entrained thereby.

An evaporation of the eluate portion, of the processed eluate portion, of the carrier fluids and/or of the analytes can also be performed outside the reactor. It is also possible to evaporate a plurality of components with the same apparatus: evaporate the carrier fluid with a first heating stage and evaporate the analytes with a second heating stage. The latter can optionally be supplied in the gas stream to a high-temperature reactor for combustion.

The inventive apparatus for isotope ratio analysis has the following features:

a) a liquid chromatograph (C), which may also be an HPLC, and which releases an eluate which comprises one or more analytes,
b) a device arranged downstream of the LC, for taking up at least a portion of the eluate of the LC and for exchanging or replacing a liquid carrier fluid present in the eluate portion with a second liquid carrier fluid and for forming an eluate portion processed in this way,
c) a device for forming one or more gaseous conversion products of the analytes from the processed eluate portion,
d) an isotope analyzer to which the gaseous conversion products can be supplied.

A detector is advantageously provided for detecting a portion of interest from the processed eluate portion. The detector signals can be used to selectively admit the portion of interest from the processed eluate portion into the device for forming one or more gaseous conversion products.

According to a further concept of the invention, the device arranged downstream of the LC, for taking up at least one eluate portion, comprises at least one separating column. On this separating column, the constituents of the eluate portion can be separated further from one another, especially the (first) liquid carrier fluid of the LC from the rest of the eluate.

Advantageously, the device arranged downstream of the LC, for taking up at least one eluate portion, has a feed apparatus for the second liquid carrier fluid. The second liquid carrier fluid can thus be supplied to the device mentioned in a controlled manner in terms of time and amount.

In a further development of the invention, it is envisaged that the device arranged downstream of the LC, for taking up at least one eluate portion, has a storage volume for the eluate portion. The feed apparatus for the second liquid carrier fluid is preferably arranged upstream of the storage volume. This allows the second liquid carrier fluid to purge the storage volume, thus transporting the eluate portion out of the storage volume.

According to a further concept of the invention, it is envisaged that the device arranged downstream of the LC, for taking up at least one eluate portion, has a multiport valve to which are connected a pump for the supply of the second liquid carrier fluid, an outlet of the liquid chromatograph, optionally a storage volume for the eluate portion and one or more columns for taking up the eluate portion or a liquid formed therefrom.

The device for formation of the gaseous conversion products may have an element analyzer. An evaporation device may be arranged upstream thereof. Alternatively or additionally, the device for formation of the gaseous conversion products may have a membrane which is gas-pervious but liquid- impervious. The isotope analyzer provided is preferably an isotope mass spectrometer (IRMS).

The process and apparatus according to the invention are preferably usable for analysis of foods, food additives, blood, plasma and urine. Target substances (analytes) are especially pharmaceuticals, metabolism products, steroids, proteins, peptides, amino acids, RNA/DNA, organic acids, pesticides and nitrates. In addition, a preferred application consists in the determination of an isotope fingerprint, specifically in the isotope ratio analysis for more than one element, especially at least two elements from the elements carbon, oxygen, nitrogen, sulfur and hydrogen.

The invention also provides a process and an apparatus corresponding to the process mentioned and the apparatus mentioned, but without also comprising the liquid chromatography process or the liquid chromatograph. The invention then relates only to the steps which follow the liquid chromatography process, i.e. to an apparatus which can be connected to a liquid chromatograph present. Of course, the abovementioned further developments of the particular invention may also relate to this process and this apparatus.

### BRIEF DESCRIPTION OF THE DRAWINGS

Further features of the invention are evident from the claims and from the rest of the description. Advantageous working examples of the invention are explained in detail hereinafter with reference to drawings. The drawings show:

FIG. 1 an inventive apparatus in standby operation,

FIG. 2 the apparatus according to FIG. 1 in the course of intermediate storage of an eluate portion of interest,

FIG. 3 the apparatus according to FIG. 1 in the course of supply of a second liquid carrier fluid and simultaneously in the course of separation from the first liquid carrier fluid,

FIG. 4 the apparatus according to FIG. 1 in the course of removal of the first liquid carrier fluid or in the course of “cutting out” of a portion of interest from the two or more carrier fluids and the eluate comprising the analyte(s),

FIG. 5 the apparatus according to FIG. 1 in the course of generation of gaseous components (conversion products) and measurement of the isotope ratios, and

FIG. 6 a modified embodiment similar to the apparatus shown in FIG. 1, except with a storage column for collection of the eluate portion of interest instead of a separating column.

### DETAILED DESCRIPTION OF PREFERRED EMBODIMENTS

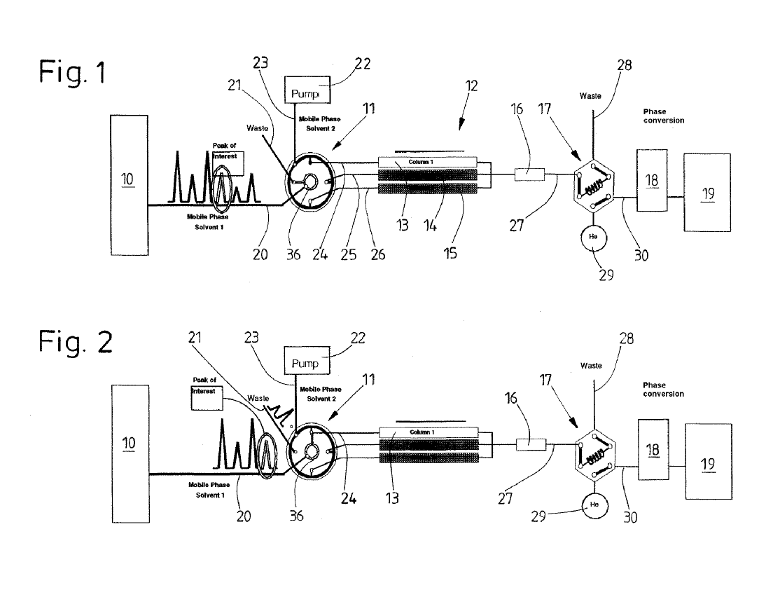

Reference is first made to FIGS. 1 to 4, with reference to which the sequence of a process according to the invention and the structure of a corresponding apparatus are explained.

Arranged downstream of a high-performance liquid chromatograph (HPLC) 10 are a switching valve 11, a group 12 of separating columns 13, 14, 15, a detector 16, a further switching valve 17, a phase convertor, configured here as an element analyzer 18, and an isotope analyzer, here as an isotope mass spectrometer (IRMS) 19.

Connected to the first switching valve 11 are a line 20 from the HPLC 10, a waste line 21, a reservoir for a second solvent with a pump 22 and an associated line 23, and three parallel lines 24, 25 and 26 to the three separating columns 13, 14, 15. The switching valve 11 may also have a storage volume 36.

The detector 16 serves for detection and transmission of signal peaks of individual analytes on the basis of the liquids leaving the separating columns 13, 14, 15. Known detectors which also have good usability in this context are at least UV detectors, PDAs (photodiode arrays), thermal conductivity detectors (TCDs) and fluorescence detectors.

Connected to the second switching valve 17 are a line 27 from the detector 16, a waste line 28, a gas source 29, a line to the element analyzer 18 and a storage volume 37 (sample loop).

In a first process step (FIG. 1), an eluate from the HPLC 10 flows via line 20 to the switching valve 11. Preference is given to using known and evaluated eluents in the HPLC. It is likewise typically known which substances are to be analyzed and when an eluate portion containing the constituents (analytes) of interest leaves the HPLC 10. Accordingly, it is possible to calculate when the relevant eluate portion reaches the switching valve 17. Alternatively or additionally, a detector which is not shown can be assigned to the HPLC 10.

The first switching valve 11 is switched in FIG. 1 such that the line 20 opens into the waste line 21. As soon as the eluate portion of interest reaches the switching valve 11, it is switched in such a way that the line 20 is connected via the storage volume 36 to the first separating column 13; see FIG. 2.

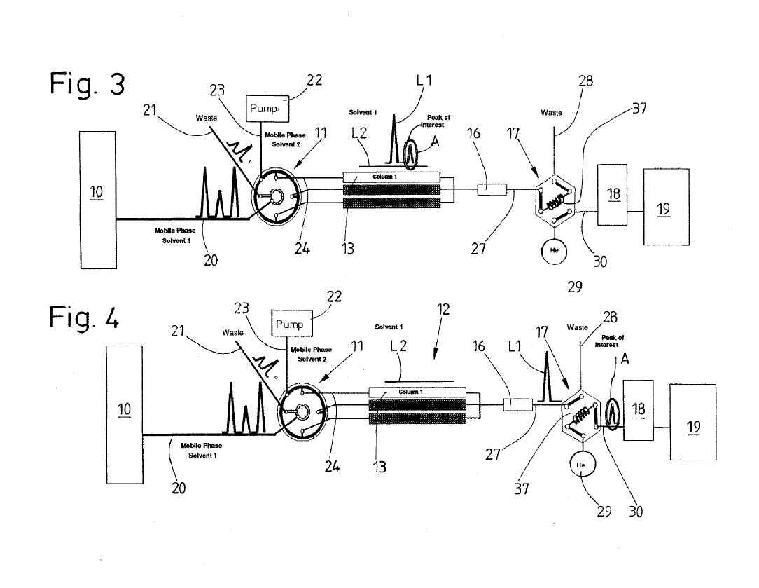

In the eluate portion of interest, there is the analyte (or more than one analyte) and a liquid carrier fluid from the HPLC 10, here a first solvent. After the eluate portion of interest has left line 20 or the HPLC 10, the switching valve 11 is switched back to the state according to FIG. 1 with the connection between line 20 and waste line 21; see FIG. 3. To increase the amount, the first process step can also be carried out more than once. The eluate portion of interest obtained in each case is then collected, for instance on the separating column 13 or in the storage volume 36.

The eluate portion of interest which is present in the separating column 13 comprises the liquid carrier fluid of the HPLC 10, namely the first solvent, and the analyte(s). A second carrier fluid, namely a second solvent here, is supplied to the separating column 13 via the pump 22 and the switching valve 11; see FIG. 3. The first solvent and the analyte pass the detector 16 successively, the latter at least in parallel to the second solvent. The output signal of the detector 16 controls the second switching valve 17 such that the first solvent L1 passes into the waste line 28 and only the analyte A with the second solvent L2 can flow into the storage volume 37; see FIG. 3. In the connection according to FIG. 4, the analyte with the second solvent passes out of the storage volume 37—as a result of the pressure of the gas source 29—to the element analyzer 18.

The contents of the separating column 13 (the stationary phase of the separating column) are preferably adjusted here with respect to the second solvent such that the latter is not retained in the separating column 13. The signals for the three different substances which are established at the detector 16 (first solvent L1, second solvent L2, analyte A) are shown in FIG. 3. The eluate which passes the detector 16 is referred to as processed eluate portion.

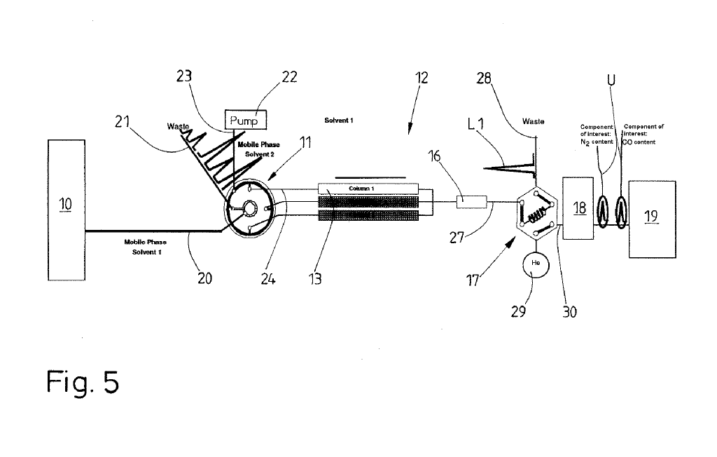

In the element analyzer 18, suitable combustion (oxidation or pyrolysis) forms the components of interest (conversion products U), for instance N₂, CO or CO₂, and they are supplied with a gaseous carrier fluid to the IRMS 19; see FIG. 5. The gaseous carrier fluid may, for example, be helium from gas source 29. It is also possible for a dedicated gas source to be assigned to the element analyzer 18. The element analyzer is preferably an apparatus corresponding to the Finnigan high temperature conversion elemental analyzer TC/EA from Thermo Electron Corporation. Constituents of this apparatus are a gas chromatograph for separation of the gaseous constituents, a suitable combustion oven and an interface for the supply of reference gases and carrier gas, and for the supply to the IRMS 19. It is advantageous to adjust the known apparatus to the relatively small amounts of sample by reducing or scaling down the volumes in the apparatus.

The further separating columns 14, 15 can be utilized to take up further eluate portions of interest from the HPLC 10. The switching valve 11 is switched correspondingly for that purpose.

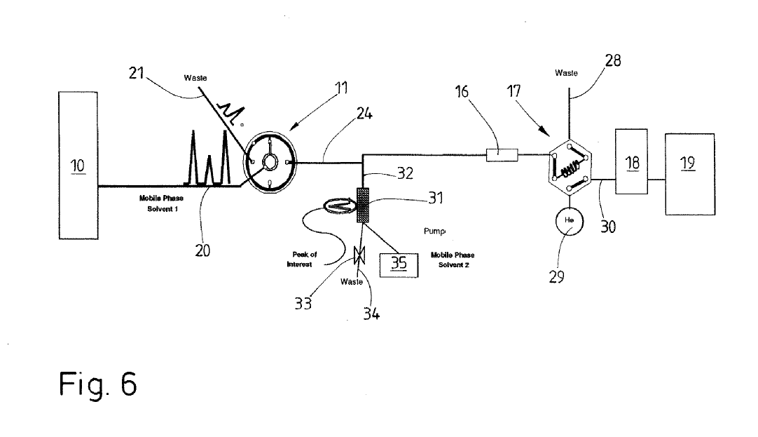

FIG. 6 shows a modified apparatus. Instead of the separating columns 13, 14, 15, a storage column 31 (trap column) is connected here via a connecting line 32 to the line 24 leading from the switching valve 11 to the detector 16.

Opposite the connecting line 32, a valve 33 is connected to the pump 31, and is connected to a waste line 34 and a pump 35 connected to a reservoir of a second solvent.

With appropriate switching of the valves 16, 17 and 33, the eluate portion of interest from the HPLC 10 passes via lines 24, 32 into the storage column 31. Undesired constituents—including the carrier fluid—can be removed via the waste line 34.

In a next step, the first switching valve 11 is closed and the substance present on the storage column 31 is conveyed by the second solvent via the detector 16 and the switching valve 17 to the elemental analyzer 18. According to the function of the storage column 31, this conveyed substance may or may not still contain the carrier fluid originating from the HPLC 10. For example, an evaporation of the first carrier fluid may be provided in the storage column 31. This makes it possible first to remove the first carrier fluid still additionally stored and only then to supply the second carrier fluid (the second solvent), in contrast to the process steps described so far.

The separating columns 13, 14, 15 shown in FIGS. 1 to 5 can also be replaced by an evaporator (PTV=Programmed Temperature Vaporizer). This also makes possible a separation of the analyte(s) from the first solvent before the supply of the second solvent.

The analysis of acetylsalicylic acid (ASA) and salicylic acid (SA) from a blood sample will be described below. This proceeds from an HPLC process described in the literature; see Analytical Chemistry, 1998, Vol. 70, 409-414, Gillian P. McMahon and Mary T. Kelly “Determination of Aspirin and Salicylic Acid in Human Plasma by Column-Switching Liquid Chromatography Using On-Line Solid Phase Extraction”.

With the known HPLC process, blood samples are analyzed for the ASA and SA content. The HPLC eluate has characteristic peaks for ASA and SA. These peaks are the parts of interest from the eluate in connection with the process according to the invention. The peaks are collected—“cut out” of the eluate—by appropriate switching of the switching valve 11 shown in FIGS. 1 to 6 and passed to a separating column and retained there by appropriate selection of the stationary phase. The carrier fluid originating from the HPLC is extracted by washing with water. This leaves the analytes (peaks) on the column. The peaks can also be stored on two different columns. Subsequently, the stored peaks (with water as the second carrier fluid) are drawn off or “freed” from the column by means of temperature gradients, inorganic buffers or acid, and supplied to the element analyzer 18 or another high-temperature reactor. The gaseous conversion products U which form there are analyzed in the isotope analyzer for the purpose of determining the isotope ratios.

### List of Reference Numerals

10 HPLC
L1 First solvent
11 Switching valve
L2 Second solvent
12 Group of separating columns
U Conversion products
13 Separating column
14 Separating column
15 Separating column
16 Detector
17 Switching valve
18 Element analyzer
19 IRMS
20 Line
21 Waste line
22 Pump
23 Line
24 Line
25 Line
26 Line
27 Line
28 Waste line
29 Gas source
30 Line
31 Storage column
32 Connecting line
33 Valve
34 Waste line
35 Pump
36 Storage volume
37 Storage volume
A Analyte

1. A process for isotope ratio analysis, comprising the steps of:
a) performing an LC process and thus providing a first eluate which comprises at least one first liquid carrier fluid and one or more analytes,
b) collecting a portion of interest from the eluate,
c) processing the eluate portion of interest by combining with a second liquid carrier fluid and removing the first carrier fluid to form a processed eluate portion,
d) processing the processed eluate portion to form at least one gaseous conversion products of the analytes, and
e) supplying the gaseous conversion products with gaseous carrier fluid to an isotope analyzer and determining the isotope ratios.

2. The process as claimed in claim 1, wherein the LC process according to step a) is an HPLC process.

3. The process as claimed in claim 1, wherein the portion of interest from the eluate is collected, stored intermediately and then processed.

4. The process as claimed in claim 3, wherein the portion of interest from the eluate is conducted through a separating column (13, 14, 15) and collected and stored intermediately there.

5. The process as claimed in claim 4, wherein the portion of interest from the eluate is collected, stored intermediately and conducted together with the second liquid carrier fluid through a separating column (13, 14, 15).

6. The process as claimed in claim 1, wherein the eluate portion is first combined with the second carrier fluid and then the first carrier fluid is removed.

7. The process as claimed in claim 1, wherein the second carrier fluid with the eluate portion or the second carrier fluid and the eluate portion which has been freed of the first carrier fluid are conducted through a separating column (13, 14, 15), and in that a portion of interest from the second eluate obtained is removed and provided for the processing of the processed eluate portion to form one or more gaseous conversion products of the analytes.

8. The process as claimed in claim 7, wherein the portion of interest from the second eluate is stored intermediately on the separating column (13, 14, 15).

9. The process as claimed in claim 1, wherein the processed eluate portion is treated physically, chemically and/or electrochemically to form the desired gaseous conversion products.

10. The process as claimed in claim 9, wherein a gas which comprises the desired analytes or conversion products thereof is obtained from the processed eluate portion, and in that the gas is separated from the liquid at least at a membrane.

11. The process as claimed in claim 9, wherein the processed eluate portion is heated to form the desired gaseous analytes or conversion products thereof, the boiling temperature of the liquid carrier fluid in the eluate portion being lower than the boiling temperature of the analytes.

12. The process as claimed in claim 9, wherein the processed eluate portion is thermally decomposed in a reactor to form the desired gaseous conversion products of the analytes.

13. The process as claimed in claim 9, wherein a gas comprising the analytes or conversion products of the analytes are obtained by electrolytic reaction of the eluate.

14. The process as claimed in claim 1, wherein the isotope analyzer used is an isotope mass spectrometer.

15. The process as claimed in claim 1, wherein the isotope analyzer used is a laser absorption measurement device.

16. The process as claimed in claim 1, wherein the collected portion of interest from the eluate is heated until the liquid carrier fluid evaporates, and in that an unevaporated portion comprises the analytes and is combined with the second carrier fluid.

17. An apparatus for isotope ratio analysis, comprising:
a) a liquid chromatograph, which releases an eluate which comprises at least one analytes,
b) LC a device arranged downstream of the liquid chromatograph, for taking up at least a portion of the eluate and for exchanging or replacing a liquid carrier fluid present in the eluate portion with a second liquid carrier fluid and for forming an eluate portion processed in this way,
c) a device for forming at least one gaseous conversion products of the analytes from the processed eluate portion, and
d) an isotope analyzer to which the gaseous conversion products can be supplied.

18. The apparatus as claimed in claim 17, further comprising a detector (16) for detecting a portion of interest from the processed eluate portion.

19. The apparatus as claimed in claim 17, wherein the device arranged downstream of the liquid chromatograph, for taking up at least one eluate portion, comprises at least one separating column (13, 14, 15).

20. The apparatus as claimed in claim 17, wherein the device arranged downstream of the liquid chromatograph, for taking up at least one eluate portion, has a feed apparatus for the second liquid carrier fluid.

21. The apparatus as claimed in claim 17, wherein the device arranged downstream of the liquid chromatograph, for taking up at least one eluate portion, has a storage volume for the eluate portion.

22. The apparatus as claimed in claim 17, wherein the device arranged downstream of the liquid chromatograph, for taking up at least one eluate portion, comprises at least one storage column (31).

23. The apparatus as claimed in claim 22, wherein the storage column (31) is attached on one side to a feed for the eluate portion and on the other side to a pump (35) for the supply of the second liquid carrier fluid.

24. The apparatus as claimed in claim 17, wherein the device arranged downstream of the liquid chromatograph, for taking up at least one eluate portion, has a multiport valve (switching valve 11) to which are connected a pump (22) for the supply of the second liquid carrier fluid, an outlet (line 20) of the liquid chromatograph, and a storage volume for the eluate portion and/or one or more columns (separating columns 13, 14, 15).

25. The apparatus as claimed in claim 17, wherein the device for forming the at least one gaseous conversion products (U) has an element analyzer (18).

26. The apparatus as claimed in claim 17, wherein the device for forming the at least one gaseous conversion products (U) has a membrane which is gas-pervious but liquid-impervious.

27. The apparatus as claimed in claim 17, wherein the isotope analyzer is an isotope mass spectrometer (19) or a laser absorption measurement device.

28. A process for isotope ratio analysis, comprising the steps of:
a) collecting a portion of interest of an eluate from an LC process, said eluate portion comprising at least one liquid carrier fluid and at least one analytes,
b) processing the eluate portion of interest by combining with a second liquid carrier fluid and removing the first carrier fluid to form a processed eluate portion,
c) processing the processed eluate portion to form at least one gaseous conversion products of the at least one analytes,
d) supplying the at least one gaseous conversion products (U) with gaseous carrier fluid to an isotope analyzer and determining the isotope ratios.

29. An apparatus for isotope ratio analysis, comprising:
a) a device for taking up a portion of the eluate from a liquid chromatograph, said eluate comprising at least one analytes, and for exchanging or replacing a liquid carrier fluid present in the eluate portion with a second liquid carrier fluid and for forming an eluate portion processed in this way,
b) a device for forming at least one gaseous conversion products of the at least one analytes from the processed eluate portion, and
c) an isotope analyzer to which the at least one gaseous conversion products (U) can be supplied.
